(19) United States
(12) Patent Application Publication
(10) Pub. No.: US 2008/0130221 A1
(43) Pub. Date: Jun. 5, 2008

(54) Thermal hinge for lid cooling

(76) Inventors: Krishnakumar Varadarajan, Bangalore (IN); Rajiv Mongia, Fremont, CA (US); Himanshu Pokharna, Santa Clara, CA (US)

Correspondence Address: INTEL CORPORATION;c/o INTELLEVATE, LLC, P.O. BOX 52050, MINNEAPOLIS, MN, 55402, US

(21) Appl. No.: 11/607,629

(22) Filed: Dec. 2, 2006

(51) Int. Cl. G06F 1/20

(52) U.S. Cl. 361/687

(57) ABSTRACT

A thermal hinge couples a computing platform to a lid. The thermal hinge includes a hinge block that has a groove passing through the hinge block and a hinge pillar to couple to the lid. The hinge pillar is inserted in a first end of the groove passing through the hinge block. The thermal hinge also includes a thermally conductive conduit inserted in a second end of the groove passing through the hinge block. The thermally conductive conduit couples with a heat spreader in the lid in order to transfer thermal energy from the hinge block to the heat spreader.

### BACKGROUND

Thermal management considerations are important for most if not all types of computing platforms. Typically, thermal management for portable computers (e.g., notebook computers) includes the use of surface area behind a display to dissipate heat generated from components resident on the computing platform for the portable computer. This surface area and display, for example, are housed or contained in a lid that is attached to the computing platform via one or more hinges. The surface area may include one or more types of thermally conductive materials and are commonly referred to as a heat spreader. Since a lid opens and closes relative to the computing platform it is attached to, a hinge at the interface coupling the lid to the computing platform likely needs to be traversed by a cooling scheme that utilizes a heat spreader in the lid.

A commonly employed cooling scheme utilizes a heat pipe in the lid and another or second heat pipe thermally coupled to components resident on the computing platform. The heat pipes are typically fragile, thin-walled cylinders which are sealed on each end and contain a fluid such as water. The heat pipes thermally couple with one another via a hinge block along the hinge axis and this type of hinge is often referred to as a thermal hinge. Several types of thermal hinge designs are currently in use. Each of these designs share a common feature: they include a hinge pillar and allow rotation of the cylindrical heat pipe within a bore or groove that passes through the hinge block or a hollow sleeve in the hinge block. These usually require very tight tolerances and relatively elaborate fastening mechanisms to achieve a thermal hinge that has an acceptable thermal performance via the heat pipe and acceptable mechanical performance via the hinge pillar.

### BRIEF DESCRIPTION OF THE DRAWINGS

FIG. 1 is an illustration of a system including an example thermal hinge to couple a computing platform to a lid;

FIG. 2 is an illustration of a close up view of a portion of the example thermal hinge;

FIG. 3 is an illustration of a perspective view of the thermal hinge; and

FIG. 4 is a flow chart of an example method to couple a lid to a computing platform with a thermal hinge and transferring thermal energy to a heat spreader in the lid via the thermal hinge.

### DETAILED DESCRIPTION

As mentioned in the background, thermal hinge designs usually require very tight tolerances and relatively elaborate fastening mechanisms to achieve a thermal hinge that has an acceptable thermal and mechanical performance. For acceptable thermal performance, the cylindrical surface of the heat pipe or other type of thermally conductive conduit needs to be thermally coupled with a hinge block for the thermal hinge. In some cases, thermal grease or lubricant is used to fill this gap and improve thermal conduction and also to reduce friction between the heat pipe and the hinge block as the lid is opened and closed. Unfortunately, even the use of thermal grease requires reasonably tight tolerances or fits at the hinge in order for the hinge (e.g., via the hinge pillar) to have adequate interference to provide enough mechanical torque to hold a lid open at various angles for possible viewing of a display housed in the lid. Also, tight fits may degrade a heat pipe or other type of thermally conductive conduit as rubbing causing thermal material to be worn down and lessens thermal performance. Thus, tight fit needs and wear and tear on a heat pipe or thermally conductive conduit are both problematic to a thermal hinge that has an acceptable thermal and mechanical performance

In one example, a thermal hinge couples a computing platform to a lid. The example thermal hinge includes a hinge block that has a groove passing through the hinge block and a hinge pillar to couple to the lid. In one example, the hinge pillar is inserted in a first end of the groove passing through the hinge block. The example thermal hinge also includes a thermally conductive conduit inserted in a second end of the groove passing through the hinge block. The thermally conductive conduit, for example, is to couple with a heat spreader in the lid in order to transfer thermal energy from the hinge block to the heat spreader. At least a portion of the thermal energy, for example, originates from a component resident on the computing platform.

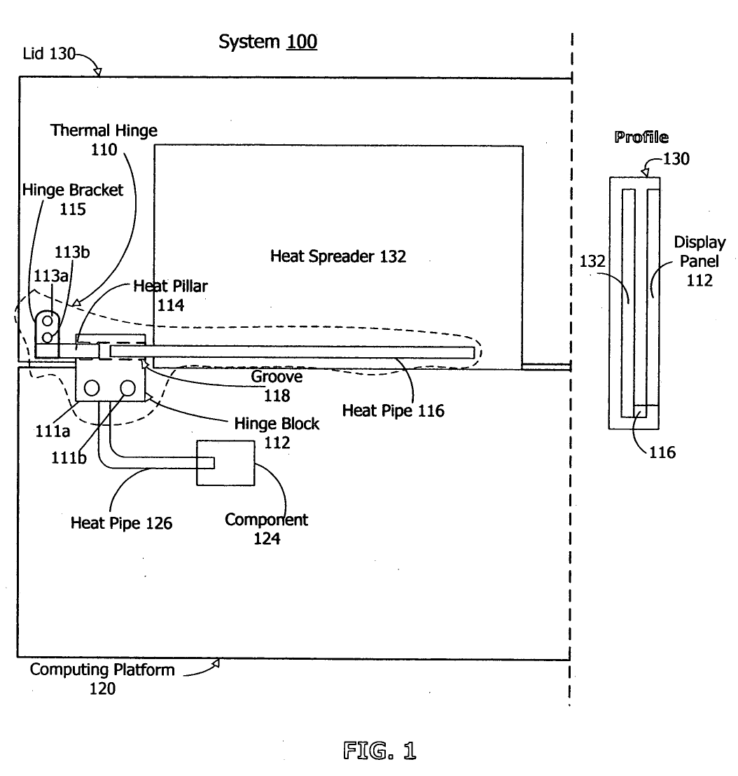

FIG. 1 is an illustration of an example system 100 including thermal hinge 110 to couple computing platform 120 to lid 130. Although not shown in FIG. 1, system 100 may also include one or more other hinges (thermal or otherwise) to couple computing platform 120 to lid 130. In one example, a left side of system 100 is shown in FIG. 1 with lid 130 in a fully opened position (e.g. 180 degrees in relation to computing platform 120) and including or housing a heat spreader 132. Heat spreader 132, for example is positioned behind display panel 134 (see profile), e.g., for a liquid crystal display (LCD).

Also depicted in FIG. 1 is computing platform 120. Computing platform 120, in one example, includes component 124 and a heat pipe 126 that is thermally coupled to component 124. Component 124 includes, but is not limited to, a microprocessor, central processing unit, memory module, graphics processor or other type of electronic component that is resident on computing platform 120 and generates a substantial amount of thermal energy or heat.

In one implementation, elements of thermal hinge 110 couple to heat spreader 132 and to heat pipe 126 to transfer thermal energy originating from component 124 to heat spreader 132. In another implementation, heat pipe 126 may be augmented with or replaced with any type of thermally conductive material (e.g., a copper, graphite, or aluminum rod/bar) to transfer thermal energy from component 124. Also, in other implementations, heat may be transferred to other types of heat absorption devices in addition to or in lieu of heat spreader 132 (e.g., a heat exchanger, heat exchanger with fan, thermoconductive conduits, etc.) located or housed within lid 130.

Although not shown in FIG. 1, system 100 may also include other elements and be a part of a computing device. This computing device may be an ultra mobile computer (UMC), a notebook computer, a laptop computer, a tablet computer, a desktop computer, a digital broadband telephony device, a digital home network device (e.g., cable/satellite/set top box, etc.), a personal digital assistant (PDA), portable game, music, and/or video player and the like.

In one example, as described more below, system 100 includes thermal hinge 110. Thermal hinge 110, for example, includes hinge block 112, hinge pillar 114 and heat pipe 116. In one implementation, hinge block 112 couples to computing platform 120 via fasteners 111a and 111b and also includes a groove 118 that passes through hinge block 112. Groove 118, for example, is shown in FIG. 1 as a dotted box to indicate that groove 118 passes through hinge block 112. Hinge pillar 114 and heat pipe 116, for example, are inserted in opposing sides or ends of groove 118.

In one example, hinge block 112 thermally couples to heat pipe 126. In this example, hinge block 112 is composed, at least in part, of thermally conductive materials. These materials may include, but are not limited to, aluminum, copper and graphite materials that may aid or facilitate the transfer of thermal energy or heat from heat pipe 126 to hinge block 112. As mention above, for example, heat pipe 126 may also thermally couple to component 124. Thus, in one example, thermal energy or heat from component 124 may be transferred via heat pipe 126 to hinge block 112.

In one example, similar to heat pipe 126, heat pipe 116 may also be augmented or replaced with any type of thermally conductive material (e.g., a copper, graphite, or aluminum rod/bar) to transfer thermal energy from hinge block 112 to heat spreader 132. Therefore this disclosure is not limited to only a heat pipe to couple with a hinge block for a thermal hinge to transfer thermal energy to a head spreader or other type of heat dissipation device in a lid.

In one implementation, thermal energy or heat is transferred from hinge block 112 to heat pipe 116 and then to heat spreader 132. As depicted in FIG. 1, heat pipe 116 is inserted in one end of groove 118. Heat pipe 116, for example, is in thermal contact or thermally couples to hinge block 112 and also thermally couples to heat spreader 132 in lid 130. Heat spreader 132, for example, is composed, at least in part, of thermally conductive materials to include, but not limited to, aluminum, copper and graphite. These materials, for example, aid or facilitate the transfer or absorption of thermal energy or heat from heat pipe 116. Thus, for example, a relatively large surface area of lid 130 is used (e.g., behind display panel 134) to dissipate thermal energy or heat that mainly originates from a component resident on computing platform 120.

In one example, hinge pillar 114 is coupled with lid 130 via hinge bracket 115. As shown in FIG. 1, for example, hinge bracket 115 is secured or mounted to lid 115 by fasteners 113a and 113b. This is just one example of how hinge pillar 114 is coupled with lid 130. In other examples hinge pillar 114 and hinge bracket may be one integrated piece. As described more below, hinge pillar 114 is inserted in groove 118 with an interference fit such that lid 130 can be positioned at a plurality of angles (e.g., for a user to view display panel 134) over a given number of cycles.

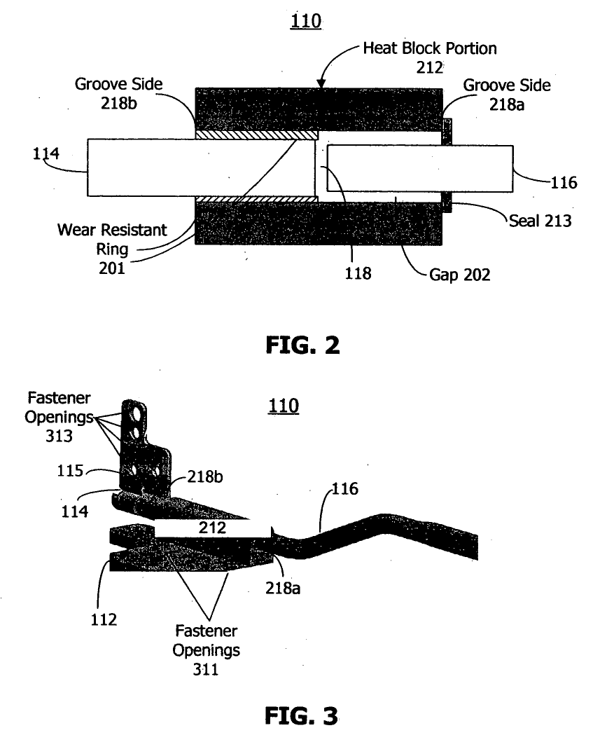

FIG. 2 is an illustration of a close up view of a portion of an example thermal hinge 110. FIG. 2 portrays, for example, groove 118 that passes through a portion of hinge block 112 that is denoted as hinge block portion 212. FIG. 2 also portrays portions of hinge pillar 114 and heat pipe 116 inserted in opposing sides or ends of groove 118. These opposing sides, for example, are shown in FIG. 2 as groove side 218a and groove side 218b.

Hinge pillar 114 and heat pipe 116, for example, are each inserted in groove 118 at a fixed length, although this disclosure is not limited to any given fixed length of insertion. This fixed length, for example, depends on the amount of mechanical torque needed by hinge pillar 114 to position a lid (e.g., lid 130) in a plurality of angles. The fixed length, for example, also depends on the amount of surface area heat pipe 116 needs to thermally couple with hinge block 112 to receive and/or absorb a desirable amount of thermal energy from hinge block 112.

In one example, groove 118 passes through hinge block 112 with a uniform diameter yet hinge pillar 114 and heat pipe 116 may have different diameters. In one implementation, as shown in FIG. 2, the diameter of hinge pillar 114 is larger than that of heat pipe 116. The diameter of hinge pillar 114, for example, is such that it creates a high interference fit of hinge pillar 114 within groove 118 yet a smaller diameter for heat pipe 116 creates a transition fit for heat pipe 116 within groove 118. This high interference fit of hinge pillar 114, for example, provides mechanical torque for hinge pillar 114 and the transition fit of heat pipe 116 provides a gap between heat pipe 116 and hinge block 112.

In one example, an interference fit provides mechanical torque for hinge pillar 114. This mechanical torque, for example, enables the lid to be opened and held in various positions such that a display in the lid can be viewed at different angles in relation to a computing platform the lid couples to via thermal hinge 110, e.g., 90 degrees, 130 degrees, 180 degrees, etc. Also, for example, the high interference fit may be snug or tight enough to maintain that mechanical torque over a large number of cycles (e.g., >20,000). Each cycle, for example, based on an opening and closing of the lid.

In one example, to further improve the reliability of the interference fit, one or more wear resistant rings are positioned within groove 118. For example, wear resistant ring 201 is shown in FIG. 2. Wear resistant ring 201, for example, is comprised of materials that help to maintain a needed mechanical torque and resist wear over a large number of lid cycles. Wear resistant ring 201 may also control a given length of hinge pillar 114 that is inserted in groove 118. In another example, a wear resistant ring may be coupled to groove side 218b in lieu of or in addition to a wear resistant ring within groove 118. This wear resistance may also assist in maintaining mechanical torque for hinge pillar 114.

The transition fit, as mentioned above for this example, provides a gap between heat pipe 116 and hinge block 112. This gap, for example, is shown in FIG. 2 as gap 202. In one example, gap 202 helps to minimize movement of heat pipe 116 for lid opening and closing cycles. Also, gap 202 is filled with thermal grease (not shown), although this disclosure is not limited to thermal grease, regular or ordinary lubricant may also fill gap 202. Therefore, for example, little or no mechanical torque is exerted on the heat pipe 116 yet the thermal grease maintains thermal conductivity between heat pipe 116 and hinge block 112. Seal 213, for example, is mounted or placed on groove side 218a to hold the thermal grease within groove 118 as well as to control a given length of heat pipe 116 that is inserted in groove 118.

FIG. 3 is an illustration of a perspective view of thermal hinge 110. As shown in FIG. 3, hinge block 112 includes hinge block portion 212 via which groove 118 passes through hinge block 112. In FIG. 3, for example, hinge block portion 212 is a raised portion of hinge block 112. Heat pipe 116 and hinge pillar 114, for example, are inserted in groove sides 218a and 218b, respectively.

As shown in FIG. 3, hinge bracket 115 includes fastener openings 313 and as mentioned for FIG. 1, in one example, hinge bracket 115 couples hinge pillar 114 to a lid (e.g., lid 130). Fastener openings 311, for example, are used along with fasteners (e.g., fasteners 113a, 113b) to mount hinge bracket 115 to that lid. Also, fastener openings 311, as portrayed in FIG. 3, may be used along with other fasteners (e.g., fasteners 111a, 111b) to mount hinge block 112 to a computer platform (e.g., computing platform 120).

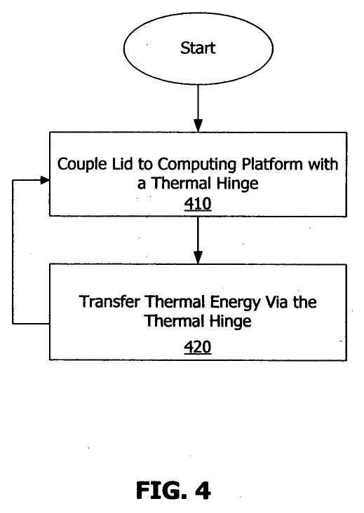

FIG. 4 is a flow chart of an example method to couple a lid to a computing platform with a thermal hinge and transferring thermal energy to a heat spreader in the lid via the thermal hinge. In one example, this method is implemented using system 100 depicted in FIG. 1. In block 410, in one example, computing platform 120 is coupled to lid 130 with thermal hinge 110 as described above for FIG. 1.

In block 420, in one example, thermal energy is transferred from component 124 resident on computing platform 120 to heat spreader 132 in lid 130 via thermal hinge 110. As described above, in one example, heat pipe 126 or a thermally conductive conduit may thermally couple to component 124 and to hinge block 112 of thermal hinge 110 to transfer heat from component 124 to hinge block 112. At least a portion of the thermal energy originating from component 124, for example, is transferred from hinge block 112 to heat pipe 116. Heat pipe 116, for example, couples with heat spreader 132 in lid 130 and further transfers at least a portion of the thermal energy originating from component 124 to heat spreader 132.

In one example, the process may start over at block 410 if thermal hinge 110 or elements coupled to thermal hinge 110 to transfer heat from component 124 are replaced. Alternatively, for example, the process may also start over at block 410 if heat is transferred from a different or an additional component resident on computing platform 120.

Referring again to FIGS. 1-3 where heat pipe 116 and 124 are depicted. While liquid and liquid vapor (e.g., water) within these heat pipes is described for examples and implementations of this disclosure, other fluid mediums can be used to transfer thermal energy. These other fluid mediums may include, but are not limited to, other types of gases, gaseous mixtures or other mediums which exhibit flow and can absorb thermal energy. In some examples, different types of mediums may be used, and certain implementation details may be altered as needed to accommodate the differences in density and flow rate of these mediums.

In the previous descriptions, for the purpose of explanation, numerous specific details were set forth in order to provide an understanding of this disclosure. It will be apparent that the disclosure can be practiced without these specific details. In other instances, structures and devices were shown in block diagram form in order to avoid obscuring the disclosure.

What is claimed is:

1. An apparatus comprising:
a thermal hinge to couple a computing platform to a lid, the thermal hinge to include:
a hinge block including a groove passing through the hinge block;
a hinge pillar to couple to the lid, the hinge pillar inserted in a first end of the groove passing through the hinge block;
a thermally conductive conduit inserted in a second end of the groove passing through the hinge block, wherein the thermally conductive conduit couples with a heat spreader in the lid to transfer thermal energy from the hinge block to the heat spreader.

2. An apparatus according to claim 1, wherein the thermally conductive conduit comprises a heat pipe.

3. An apparatus according to claim 1, wherein the thermally conductive conduit includes one of a copper rod, an aluminum rod and a graphite rod.

4. An apparatus according to claim 1, further comprising:
another heat pipe coupled with the hinge block and to couple with a component resident on the computing platform, the other heat pipe to transfer thermal energy from the component to the hinge block.

5. An apparatus according to claim 1, further comprising:
a thermally conductive conduit coupled with the hinge block and to thermally couple with a component resident on the computing platform, the thermally conductive conduit to transfer thermal energy from the component to the hinge block.

6. An apparatus according to claim 1, wherein the hinge pillar inserted in the first end of the groove passing through the hinge block is inserted with an interference fit that provides mechanical torque such that the lid can be positioned at a plurality of angles over a given number of cycles, a cycle based on an opening and a closing of the lid.

7. An apparatus according to claim 6, wherein a wear resistant ring is positioned within the first end of the groove passing through the hinge block to maintain the mechanical torque over the given number of cycles.

8. An apparatus according to claim 6, wherein a wear resistant ring is coupled with the second end of the groove and the hinge pillar is coupled with the wear resistant ring to maintain the mechanical torque over the given number of cycles.

9. An apparatus according to claim 1, wherein the heat pipe inserted in the second end of the groove passing through the hinge block is inserted with a transition fit such that a gap is between the heat pipe and the groove passing through the heat block, the gap to be filled with a material that provides thermal conduction between the heat pipe and the hinge block.

10. An apparatus according to claim 9, wherein the thermal material that provides thermal conduction between the heat pipe and the hinge block comprises thermal grease.

11. An apparatus according to claim 10, wherein a seal is coupled with the second end of the groove to maintain the thermal grease in the gap and to maintain a given length of the heat pipe in the groove.

12. An apparatus according to claim 1, wherein the groove passing through the hinge block comprises the groove passing through the hinge block with a uniform dimension to include a uniform diameter.

13. A method comprising:
coupling a lid to a computing platform with a thermal hinge that includes:
a hinge block including a groove passing through the hinge block;
a hinge pillar to couple to the lid, the hinge pillar inserted in a first end of the groove passing through the hinge block; and
a thermally conductive conduit inserted in a second end of the groove passing through the hinge block, the thermally conductive conduit to couple with a heat spreader in the lid to transfer thermal energy from the hinge block to the heat spreader; and
transferring thermal energy from a component resident on the computing platform to the heat spreader in the lid via the thermal hinge.

14. A method according to claim 13, wherein transferring thermal energy from the component to the thermal hinge comprises coupling another heat pipe with the component and the thermal hinge.

15. A method according to claim 13, wherein transferring thermal energy from the component to the thermal hinge comprises coupling a thermally conductive conduit with the component and the thermal hinge, the thermally conductive conduit to include one of a copper rod, an aluminum rod and a graphite rod.

16. A system comprising:
a computing platform including a heat generating component;
a lid including a heat spreader; and
a thermal hinge to couple the computing platform to the lid, the thermal hinge to include:
a hinge block including a groove passing through the hinge block;
a hinge pillar to couple to the lid, the hinge pillar inserted in a first given end of the groove passing through the hinge block; and
a heat pipe inserted in a second end of the groove passing through the hinge block, wherein the heat pipe thermally couples to the heat spreader to transfer thermal energy from the hinge block to the heat spreader.

17. A system according to claim 16, further comprising:
another heat pipe coupled with the hinge block and to thermally couple with the heat generating component resident on the computing platform, the other heat pipe to transfer at least a portion of the thermal energy from the heat generating component to the hinge block.

18. A system according to claim 16, wherein the heat generating component comprises one of a microprocessor, a central processing unit, a memory module and a graphics processor.

19. A system according to claim 16, wherein the hinge pillar inserted in the first end of the groove passing through the hinge block is inserted with an interference fit that provides mechanical torque such that the lid can be positioned at a plurality of angles over a given number of cycles, a cycle based on an opening and a closing of the lid.

20. A system according to claim 19, wherein the plurality of angles comprises the plurality of angles to include one of 90 degrees in relation to the computing platform and 130 degrees in relation to the computing platform.

21. A system according to claim 16, wherein the heat pipe inserted in the second end of the groove passing through the hinge block is inserted with a transition fit such that a gap is between the heat pipe and the groove passing through the heat block, the gap to be filled with a material that provides thermal conduction between the heat pipe and the hinge block.
